(19) United States
(12) Patent Application Publication
(10) Pub. No.: US 2026/0292329 A1
(43) Pub. Date: Sep. 24, 2026

(54) INTERACTION METHOD, APPARATUS, DEVICE, MEDIUM, AND PRODUCT

(71) Applicant: Beijing Zitiao Network Technology Co., Ltd., Beijing (CN)

(72) Inventors: Guangqi CHEN, Beijing (CN); Yuan GAO, Beijing (CN); Jizhe XIA, Beijing (CN)

(21) Appl. No.: 19/572,676

(22) Filed: Mar. 19, 2026

(30) Foreign Application Priority Data
Mar. 20, 2025 (CN) 202510338817.8

(51) Int. Cl. H04N 23/63; H04N 23/611

(52) U.S. Cl. CPC H04N 23/633; H04N 23/611

(57) ABSTRACT

Provided are an interaction method and apparatus, a device, a medium and a product in the technical field of photographing. The method includes: for a shooting interface being displayed, if it is detected that an operation of acquiring a reference image is triggered on the shooting interface, extracting at least one posture shooting key point from the reference image; and then detecting a viewfinder image displayed on the shooting interface based on the at least one posture shooting key point to obtain a detection result, so that the detection result includes a matching result between each of the at least one posture shooting key point and the viewfinder image, the shooting interface is updated subsequently based on the detection result.

### CROSS-REFERENCE TO RELATED APPLICATIONS

The present application is based on and claims priority to Chinese Patent Application No. 202510338817.8, and filed on Mar. 20, 2025, the entire disclosure of the Chinese Patent Application is hereby incorporated by reference in its entirety.

### TECHNICAL FIELD

The present disclosure relates to the technical field of photographing, and in particular, to an interaction method, an apparatus, a device, a medium, and a product.

### BACKGROUND

With popularization of electronic devices (such as terminal devices), the electronic devices have more and more functions. The photographing function of the electronic device is widely used by users, so how to use the electronic device to take images with better quality has become an urgent technical problem to be solved.

### SUMMARY

In order to solve the above technical problems, the present disclosure provides an interaction method, an apparatus, a device, a medium, and a product.

In order to achieve the above objective, the technical solutions provided by the present disclosure are as follows:

The present disclosure provides an interaction method, including: displaying a shooting interface; in response to detecting an operation of acquiring a reference image that is triggered on the shooting interface, acquiring at least one posture shooting key point from the reference image, wherein different posture shooting key points describe different body parts; and detecting, based on the at least one posture shooting key point, a viewfinder image displayed on the shooting interface to obtain a detection result, wherein the detection result includes a matching result between each of the at least one posture shooting key point and the viewfinder image, and updating the shooting interface based on the detection result.

In a possible implementation, the updating the shooting interface based on the detection result includes: in response to detecting that the detection result indicates that there is a key point in the at least one posture shooting key point which is mismatched with the viewfinder image, updating the shooting interface based on the mismatched key point, wherein the mismatched key point is highlighted on the updated shooting interface.

In a possible implementation, the updating the shooting interface based on the mismatched key point includes: in response to detecting that the at least one posture shooting key point is displayed on the viewfinder image, adjusting a display state of the mismatched key point on the viewfinder image, wherein a highlighting level of the display state after the adjustment is higher than a highlighting level of the display state before the adjustment; and/or, in response to detecting that the at least one posture shooting key point is not displayed on the viewfinder image, adding and displaying the mismatched key point on the viewfinder image according to a position of the body part described by the mismatched key point in the viewfinder image.

In a possible implementation, the updating the shooting interface based on the mismatched key point includes: adding and displaying suggestion information corresponding to the mismatched key point on the shooting interface, wherein the suggestion information describes an adjustment process of changing from a posture of the body part described by the mismatched key point in the viewfinder image to a posture indicated by the mismatched key point.

In a possible implementation, after the updating the shooting interface based on the detection result, the method further includes: in response to detecting an operation of displaying the reference image that is triggered on the shooting interface, displaying a thumbnail of the reference image at a preset position in the viewfinder image, or adding and displaying a transparent layer on the viewfinder image, wherein the reference image is displayed on the transparent layer.

In a possible implementation, a key point in the at least one posture shooting key point, that is mismatched with the viewfinder image, is displayed on the updated shooting interface; and the method further includes: in response to detecting an operation of ignoring the mismatched key point that is triggered on the updated shooting interface, updating the detection result, wherein the updated detection result indicates that the mismatched key point is in a matching state with the viewfinder image, or the updated detection result indicates that there is no the mismatched key point in the at least one posture shooting key point, and continuing to perform the updating the shooting interface based on the detection result.

In a possible implementation, after the updating the shooting interface based on the detection result, the method further includes: in response to detecting that the detection result indicates that there is a key point in the at least one posture shooting key point which is mismatched with the viewfinder image, continuing to perform the detecting, based on the at least one posture shooting key point, the viewfinder image displayed on the shooting interface to obtain the detection result.

In a possible implementation, the method further includes: in response to detecting that a duration in which the mismatched key point is in a mismatching state with the viewfinder image reaches a preset duration, updating the detection result, wherein the updated detection result indicates that the mismatched key point is in a matching state with the viewfinder image or the updated detection result indicates that there is no the mismatched key point in the at least one posture shooting key point, and continuing to perform the updating the shooting interface based on the detection result.

In a possible implementation, in response to detecting that a duration in which the mismatched key point is in a mismatching state with the viewfinder image reaches a preset duration, updating the detection result, includes: in response to detecting that the duration in which the mismatched key point is in the mismatching state with the viewfinder image reaches the preset duration, displaying preset information on the shooting interface, wherein the preset information inquires whether to ignore the mismatched key point; and in response to detecting that a trigger operation for the preset information indicates to ignore the mismatched key point, updating the detection result.

In a possible implementation, the updating the shooting interface based on the detection result includes: in response to detecting that the detection result indicates that there is a key point in the at least one posture shooting key point which is matched with the viewfinder image, updating the shooting interface based on the matched key point, wherein the matched key point is weakly displayed or not displayed on the updated shooting interface.

In a possible implementation, the updating the shooting interface based on the detection result includes: in response to detecting that the detection result indicates that each key point in the at least one posture shooting key point is matched with the viewfinder image, shooting the viewfinder image, or displaying prompt information on the shooting interface, wherein the prompt information indicates that the viewfinder image meets a shooting requirement.

In a possible implementation, the method is applied to an electronic device, and the method further includes: synchronizing the shooting interface to a display device, wherein the display device is independent of the electronic device.

In a possible implementation, the method further includes: converting text data generated based on the detection result into speech data for playing, wherein the text data indicates a matching result between some or all of the at least one posture shooting key point and the viewfinder image; or, converting some or all of the updated shooting interface into speech data for playing.

In a possible implementation, in response to detecting the operation of acquiring the reference image that is triggered on the shooting interface, acquiring the at least one posture shooting key point from the reference image, includes: in response to detecting the operation of acquiring the reference image that is triggered on the shooting interface, displaying the reference image in a display area of the shooting interface; in response to detecting an operation of analyzing the reference image that is triggered on the shooting interface, analyzing the reference image to obtain the at least one posture shooting key point, and adding and displaying each posture shooting key point on the reference image according to a position of a body part described by each posture shooting key point in the reference image; and the detecting, based on the at least one posture shooting key point, the viewfinder image displayed on the shooting interface to obtain the detection result includes: in response to detecting an operation of displaying the viewfinder image that is triggered on the shooting interface, displaying the viewfinder image in the display area, and detecting, based on the at least one posture shooting key point, the viewfinder image displayed on the shooting interface to obtain the detection result..

The present disclosure provides an interaction apparatus, including: a first display unit, configured to display a shooting interface; a key point acquisition unit, configured to, in response to detecting an operation of acquiring a reference image that is triggered on the shooting interface, acquire at least one posture shooting key point from the reference image, wherein different posture shooting key points describe different body parts; and a first updating unit, configured to detect, based on the at least one posture shooting key point, a viewfinder image displayed on the shooting interface to obtain a detection result, wherein the detection result comprises a matching result between each key point in the at least one posture shooting key point and the viewfinder image, and update the shooting interface based on the detection result.

The present disclosure provides an electronic device, including: a processor and a memory, where the memory is configured to store instructions or a computer program, and the processor is configured to execute the instructions or the computer program in the memory to cause the electronic device to perform the interaction method provided by the present disclosure.

The present disclosure provides a computer-readable medium, where instructions or a computer program are stored in the computer-readable medium, and the instructions or the computer program, when running on a device, cause the device to perform the interaction method provided by the present disclosure.

The present disclosure provides a computer program product, including a computer program carried on a non-transitory computer-readable medium, where the computer program includes program codes for performing the interaction method provided by the present disclosure.

### BRIEF DESCRIPTION OF THE DRAWINGS

In order to more clearly describe the technical solutions in the embodiments of the present disclosure or in the related art, the following will briefly introduce the drawings that need to be used in the description of the embodiments or related art. Obviously, the drawings in the following description are only some embodiments recorded in the present disclosure. For those of ordinary skilled in the art, other drawings may be obtained based on these drawings without paying any creative effort.

FIG. 1 is a flowchart of an interaction method provided by an embodiment of the present disclosure;

FIG. 2 is a schematic diagram of an acquisition process of a reference image provided by an embodiment of the present disclosure;

FIG. 3 is a schematic diagram of adding and displaying a shooting key point in a reference image provided by an embodiment of the present disclosure;

FIG. 4 is a schematic diagram of switching from a reference image to a viewfinder image provided by an embodiment of the present disclosure;

FIG. 5 is a schematic diagram of updating by adding and displaying a mismatched key point provided by an embodiment of the present disclosure;

FIG. 6 is a schematic diagram of adding and displaying a shooting key point on a viewfinder image provided by an embodiment of the present disclosure;

FIG. 7 is a schematic diagram of a highlighting manner provided by an embodiment of the present disclosure;

FIG. 8 is a schematic diagram of updating by adding and displaying an adjustment suggestion provided by an embodiment of the present disclosure;

FIG. 9 is a schematic diagram of a weak displaying manner provided by an embodiment of the present disclosure;

FIG. 10 is a schematic diagram of displaying a reference image through a thumbnail provided by an embodiment of the present disclosure;

FIG. 11 is a schematic diagram of displaying a reference image through a transparent layer provided by an embodiment of the present disclosure;

FIG. 12 is a schematic diagram of a key point ignoring process provided by an embodiment of the present disclosure;

FIG. 13 is a schematic diagram of a shooting process provided by an embodiment of the present disclosure;

FIG. 14 is a structural schematic diagram of an interaction apparatus provided by an embodiment of the present disclosure; and

FIG. 15 is a structural schematic diagram of an electronic device provided by an embodiment of the present disclosure.

### DETAILED DESCRIPTION OF EMBODIMENTS

The research has found that in order to better shoot images with better quality, electronic devices provide some photographing assistance technologies, such as automatic parameter (such as exposure, white balance and other parameters) setting, autofocusing, and other technologies, so that these technologies may provide assistance in some shooting details.

The research has also found that the photographing assistance technologies shown in the previous paragraph are more suitable for providing assistance to a photographer with certain photographic knowledge, so that when the photographer has already conceived how to take pictures, these technologies may assist the photographer to take pictures according to his/her conception, so that high-quality images may be better taken with the assistance of these technologies.

The research has also found that for some photographers (such as a photographer with insufficient photographic knowledge reserve, or a photographer who cannot conceive how to take pictures), these photographers have little idea how to take pictures in the current environment (such as, an idea of which posture of the shot object is better for taking pictures, etc.), so that it is difficult for these photographers to shoot high-quality images with the help of the photographing assistance technologies shown in the above two paragraphs, thus affecting the photographing experience.

Based on the above research, in order to better improve the photographing experience, the present disclosure provides an interaction method, the method includes: for a shooting interface being displayed, if it is detected that an operation of acquiring a reference image (such as a high aesthetic image) is triggered on the shooting interface, at least one posture shooting key point, for example, key point such as "head tilted slightly upward", "hand supporting a colorful umbrella", and "legs bent on bench", is first acquired from the reference image; and then a viewfinder image displayed on the shooting interface is detected based on the at least one posture shooting key point to obtain a detection result, so that the detection result includes a matching result between each key point in the at least one posture shooting key point and the viewfinder image, and the detection result may indicate whether the current viewfinder image may meet these key points, then the shooting interface may be updated subsequently based on the detection result, the updated shooting interface may represent the detection result to some extent, and a photographer may know the deficiencies of the current viewfinder image from the updated shooting interface, so that the photographer may guide a shot object to adjust its posture based on the updated shooting interface subsequently, therefore, the shooting can be made under the guidance of such key points, and a high-quality image may be shot under the guidance of such key points, which can effectively overcome the defects due to the photographer’s inability to conceive how to take pictures, and thus is favorable for improving shooting experience. In addition, since different posture shooting key points describe different body parts, these key points may fully describe posture details described by the reference image, so that an image shot under the guidance of such key points may restore the posture described by the reference image as much as possible, which is further favorable for better improving the shooting quality.

In addition, the present disclosure does not limit an execution subject of the interaction method provided by the present disclosure, for example, the method may be applied to a terminal device. For another example, the method may also be implemented by a data processing process for data table data between a terminal device and a server. The terminal device may be a smart phone, a computer, a Personal Digital Assistant (PDA), a tablet computer, etc. The server may be a stand-alone server, a cluster server, or a cloud server.

In order to enable those skilled in the art to better understand the solutions of the present disclosure, the technical solutions in the embodiments of the present disclosure will be clearly and completely described below in combination with the drawings in the embodiments of the present disclosure. Obviously, the described embodiments are only part of the embodiments of the present disclosure, rather than all the embodiments. Based on the embodiments in the present disclosure, all other embodiments obtained by those ordinary skilled in the art without paying any creative effort shall fall within the protection scope of the present disclosure.

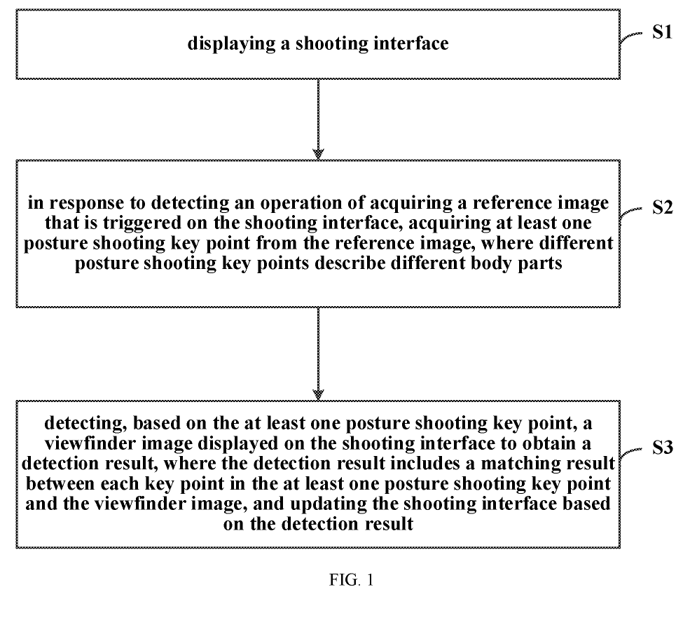

In order to better understand the technical solutions provided by the present disclosure, the interaction method provided by the present disclosure will be described below in combination with some drawings. As shown in FIG. 1, an interaction method provided by an embodiment of the present disclosure includes the following S1-S3.

S1: displaying a shooting interface.

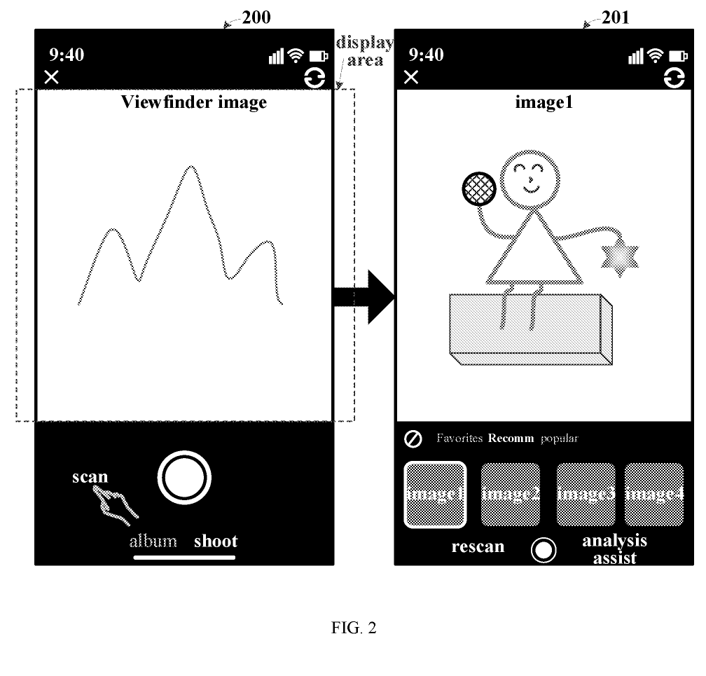

The shooting interface (also referred to as a camera interface) refers to an interface used during photographing, such as the shooting interface 200 shown in FIG. 2, so that a photographer may perform photographing by some operations triggered on the shooting interface subsequently.

In addition, the present disclosure does not limit an implementation of the shooting interface, for example, it may be implemented with any shooting interface.

For another example, in a possible implementation, the shooting interface may include a display area (such as the display area shown in FIG. 2) and an operation area (areas in the shooting interface 200 other than the display area shown in FIG. 2). The display area is configured to provide an information display function, so that the display area may at least display some content, such as a viewfinder image (such as the viewfinder image shown in the shooting interface 200 in FIG. 2), for a user to view. The operation area is configured to provide some operation functions (such as a shooting operation), so that the operation area may at least provide some interaction functions for the photographer. It should be noted that the viewfinder image refers to an image that is selected by a viewfinding apparatus (such as a viewfinder) on a camera during shooting and that may define a range of scenery to be taken into a negative film.

In addition, the present disclosure does not limit a process for entering the shooting interface, for example, it may be implemented with any process that may enter the shooting interface. For ease of understanding, the following describes two examples.

Example 1: when the interaction method provided by the present disclosure is applied to an electronic device, if an application (App) that may provide a shooting function is deployed on the electronic device (such as a terminal device similar to a mobile phone, etc.), the process for entering the shooting interface may include: in response to detecting an operation of opening the App that is triggered on the electronic device (such as a click operation triggered on an icon of the App or an operation of selecting the App from multiple applications running in the background to run in the foreground, etc.), displaying the shooting interface (such as the shooting interface 200 shown in FIG. 2) on the electronic device, and displaying a viewfinder image on the shooting interface.

Example 2: when the interaction method provided by the present disclosure is applied to an electronic device, if the electronic device is a certain image collection device (such as a camera, a single-lens reflex camera and other devices), the process for entering the shooting interface may include: in response to detecting a power-on operation that is triggered for the electronic device (such as an operation of pressing a power-on button, etc.), displaying the shooting interface on the electronic device, and displaying a viewfinder image on the shooting interface.

Based on the relevant content of S1 mentioned above, for any electronic device (such as a mobile phone, a computer, or a camera and other devices) that may provide a photographing function, if it is detected that an operation of entering a shooting interface is triggered on the electronic device, the shooting interface is displayed on the electronic device, and a viewfinder image is displayed in a display area of the shooting interface.

S2: in response to detecting an operation of acquiring a reference image that is triggered on the shooting interface, acquiring at least one posture shooting key point from the reference image, where different posture shooting key points describe different body parts.

The reference image refers to an image (such as the image 1 shown in FIG. 2) which would be referred to during shooting, so that the reference image may describe how to shoot a high-quality image in the current shooting, and the reference image may be used as a reference guide to guide the current shooting, and the reference image may provide some guidance for the current shooting (such as, a guidance of which posture of the shot object is better looking, etc.), so that the defects caused by the photographer's inability to conceive how to shoot may be better overcome.

In addition, the present disclosure does not limit the reference image, for example, the reference image may meet at least some or all of the following constraints: a similarity degree between a background of the reference image and an current shooting environment state (such as a color distribution state, a light distribution state, etc.) exceeds a first preset threshold; a similarity degree between a dressing of a person in the reference image and a dressing (such as makeup, clothing, etc.) of the shot object in the current shooting exceeds a second preset threshold; and the reference image belongs to a high-quality image or a high aesthetic image (for example, an image with a higher score obtained by scoring according to some or all of indicators such as the number of reposts, the number of likes, or the number of favorites, etc.).

It should be noted that the present disclosure does not limit an acquisition manner of "the current shooting environment state", for example, " the current shooting environment state" may be obtained by any method that may acquire a shooting environment, for example, through inputting environment description information (such as text and/or images) by a related person. For another example, in order to better improve flexibility, "the current shooting environment state" may also be obtained by real-time acquisition using an electronic device that is displaying the shooting interface, so that the viewfinder image being displayed on the electronic device may describe "the current shooting environment state" in real time, which is favorable for realizing that the photographer obtains "the current shooting environment state" by shooting the surrounding environment (such as the scanning function shown in the shooting interface 200 in FIG. 2).

It should also be noted that the present disclosure does not limit an acquisition manner of the "dressing of the shot object in the current shooting", for example, the "dressing of the shot object in the current shooting" may be obtained by any method that may acquire the dressing of the shot object, for example, through inputting dressing description information (such as text and/or images) by a related person. For another example, in order to better improve flexibility, the "dressing of the shot object in the current shooting" may also be obtained by real-time collection using an electronic device that is displaying the shooting interface, so that the viewfinder image being displayed on the electronic device may describe the "dressing of the shot object in the current shooting" in real time, which is favorable for realizing that the photographer obtains the "dressing of the shot object in the current shooting" by shooting the shot object.

In addition, the above "operation of acquiring the reference image" refers to an operation that is triggered on the shooting interface in a display state to request to acquire the reference image, and the present disclosure does not limit an implementation of the "operation of acquiring the reference image", for example, the "operation of acquiring the reference image" may include an operation of providing an image (such as an image uploading operation, etc.) that is triggered by the user on the shooting interface. For another example, the "operation of acquiring the reference image" may include an operation of selecting an image from multiple candidate images (such as images 1 to 4 shown in the shooting interface 201 in FIG. 2) provided by the shooting interface. Therefore, in a possible implementation, the reference image may be provided by the user to the electronic device that is displaying the shooting interface in a certain manner, or the reference image refers to an image (such as the image 1 shown in FIG. 2) selected from some candidate images provided by the shooting interface (such as the shooting interface 201 shown in FIG. 2) displayed by the electronic device.

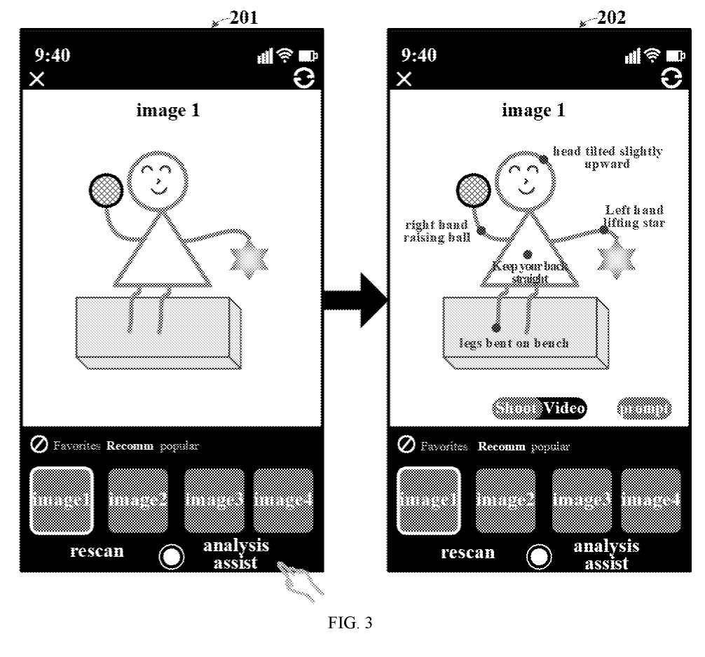

In addition, for the above reference image, the at least one posture shooting key point extracted from the reference image is obtained by performing shooting key point analysis (such as the analysis assistance function shown in the shooting interface 201 in FIG. 3) on the reference image, so that the at least one posture shooting key point (such as each key point shown in the shooting interface 202 in FIG. 3) may describe a state of a person in the reference image, such as a posture of each body part. Because different posture shooting key points describe different body parts, the at least one posture shooting key point may describe the state of the person in the reference image as comprehensively as possible, so that the at least one posture shooting key point can serve as guidance information to influence the current shooting subsequently.

In addition, the present disclosure does not limit the acquisition manner of the at least one posture shooting key point, for example, the acquisition process of the at least one posture shooting key point may include: if it is detected that the operation of acquiring the reference image is triggered on the shooting interface, searching for at least one posture shooting key point corresponding to the reference image from a pre-built mapping relationship as the at least one posture shooting key point. The mapping relationship is used to record posture shooting key points corresponding to each reference image.

For another example, the acquisition process of the at least one posture shooting key point may include: if it is detected that the operation of acquiring the reference image is triggered on the shooting interface, analyzing the reference image with a pre-built machine learning model having a shooting key point (such as a posture shooting key point) analysis function to obtain the at least one posture shooting key point. It should be noted that the present disclosure does not limit the implementation of the machine learning model, for example, it may be implemented with a visual language model. In this way, in a possible implementation, after the reference image is acquired, a shooting key point analysis may be performed on the reference image based on the visual language model to obtain shooting key points output by the visual language model, such as the at least one posture shooting key point.

For another example, in some scenarios, such as a scenario where there are some comments and/or videos commenting on advantages of the reference image, the acquisition process of the at least one posture shooting key point may include: if it is detected that the operation of acquiring the reference image is triggered on the shooting interface, performing shooting key point analysis based on the reference image and information (such as comments, explanation videos and other information) associated with the reference image to obtain the at least one posture shooting key point, so that the at least one posture shooting key point may more accurately represent the advantages of the reference image, and the at least one posture shooting key point may more accurately represent how to shoot a high-quality image. Because the associated information may indicate the advantages of the reference image, the at least one posture shooting key point determined based on the associated information may also represent the advantages, thereby an image shot with the at least one posture shooting key point as guidance may inherit the advantages as much as possible, which is favorable for better improving shooting experience. It should be noted that the present disclosure does not limit the acquisition manner of the associated information.

S3: detecting, based on the at least one posture shooting key point, a viewfinder image displayed on the shooting interface to obtain a detection result, where the detection result includes a matching result between each key point in the at least one posture shooting key point and the viewfinder image, and updating the shooting interface based on the detection result.

The detection result is obtained by detecting a viewfinder image being displayed on the shooting interface (for example, a viewfinder image that is acquired in real time) based on the at least one posture shooting key point, so that the detection result includes the matching result between each key point in the at least one posture shooting key point and the viewfinder image, and the detection result may indicate whether the viewfinder image matches each key point in the at least one posture shooting key point, and the detection result may indicate whether the viewfinder image may meet each key point in the at least one posture shooting key point, so that the shooting interface may be updated subsequently based on the detection result, the updated shooting interface may present the detection result to some extent, and the photographer may know the detection result through the updated shooting interface.

It should be noted that the present disclosure does not limit the acquisition manner of the above detection result, for example, it may be implemented by any method that may evaluate whether some information (such as text) matches an image. For another example, in some scenarios, the detection result may be determined by a visual language model based on a dual tower structure, such as a Contrastive Language-Image Pre-training (CLIP) model, and the determination process may be: providing the viewfinder image as one-way input to the model, and providing the at least one posture shooting key point (or a feature vector of the at least one posture shooting key point) as another-way input to the model, so that the model may calculate a matching degree between the two-way inputs to obtain and output the detection result, so that the detection result may indicate whether the viewfinder image meets these key points. It should be noted that the present disclosure does not limit the implementation of the detection result, for example, it may be implemented by text or a matching degree.

In addition, the present disclosure does not limit the implementation of the step of "updating the shooting interface based on the detection result" in the above S3, for example, it may be specifically: adding and displaying the detection result in the shooting interface, so that the photographer may know the detection result through the shooting interface.

It may be seen from the relevant content of the above S1 to S3 that the photographing process provided by the present disclosure includes: for a shooting interface being displayed, if it is detected an operation of acquiring a reference image (such as the image 1 shown in FIG. 3) is triggered on the shooting interface, acquiring at least one posture shooting key point (such as a shooting key point of "head tilted slightly upward" shown in the shooting interface 202 in FIG. 3) from the reference image; and then detecting a viewfinder image displayed on the shooting interface based on the at least one posture shooting key point to obtain a detection result, so that the detection result includes a matching result between each key point in the at least one posture shooting key point and the viewfinder image, and the detection result may indicate whether the current viewfinder image may meet these key points, then the shooting interface may be updated subsequently based on the detection result, the updated shooting interface may represent the detection result to some extent, and a photographer may know the deficiencies of the current viewfinder image from the updated shooting interface, so that the photographer may guide a shot object to adjust its posture based on the updated shooting interface subsequently, therefore, the shooting can be made under the guidance of such key points, and a high-quality image may be shot under the guidance of such key points, which can effectively overcome the defects due to the photographer’s inability to conceive how to take pictures, and thus is favorable for improving shooting experience. In addition, since different posture shooting key points describe different body parts, these key points may fully describe posture details described by the reference image, so that an image shot under the guidance of such key points may restore the posture described by the reference image as much as possible, which is further favorable for better improving the shooting quality.

The research has found that in some shooting scenarios, the reference image may be used not only to provide guidance for a person's posture, but also to provide guidance for shooting in terms of light, color, composition and other aspects, so as to shoot better quality images.

Based on the above research, in order to better improve the shooting effect, the acquisition process of the above detection result may at least include: detecting, based on shooting key points in multiple dimensions extracted from the reference image, the viewfinder image displayed on the shooting interface to obtain the detection result, so that the detection result includes a matching result between the shooting key point in each dimension in the multiple dimensions and the viewfinder image, and the detection result may indicate whether the viewfinder image may meet the shooting key point in each dimension in the multiple dimensions. The shooting key points in the multiple dimensions include not only the at least one posture shooting key point, but also a light shooting key point, a color shooting key point, a composition shooting key point, etc., so that the shooting key points in the multiple dimensions may describe characteristics (such as advantages) of the reference image as comprehensively as possible, and an image shot under the guidance of the shooting key points in the multiple dimensions may inherit these characteristics as much as possible, which is favorable for better improving the shooting effect.

It should be noted that the present disclosure does not limit a manner of determining the above multiple dimensions, for example, the multiple dimensions may be determined according to shooting requirements of an actual application scenario (such as requirements for which dimension of shooting quality the application scenario more focuses on) and/or information (such as comments, explanation videos and other information) associated with the reference image, so that the multiple dimensions may describe the advantages of the reference image as comprehensively as possible, so that the reason why the reference image belongs to a high-quality image may be described as accurately as possible subsequently through the shooting key points in the multiple dimensions, and the image shot under the guidance of the shooting key points in the multiple dimensions may inherit these advantages as much as possible, which is favorable for better improving the shooting effect.

The research has found that in some scenarios, in the process of shooting under guidance of the reference image, the photographer may more focus on shooting key points that are still not met by the current viewfinder image, therefore, in order to better meet the above requirements, the step of "updating the shooting interface based on the detection result" in the above S3 may include: in response to detecting that the detection result indicates that there is a key point in the at least one posture shooting key point which is mismatched with the viewfinder image, updating the shooting interface based on the mismatched key point, wherein the mismatched key point is highlighted on the updated shooting interface, so that the photographer may quickly find out the issues existing in the current viewfinder image through the updated shooting interface, which is favorable for correcting these issues subsequently under the guidance of these key points, thereby improving shooting efficiency.

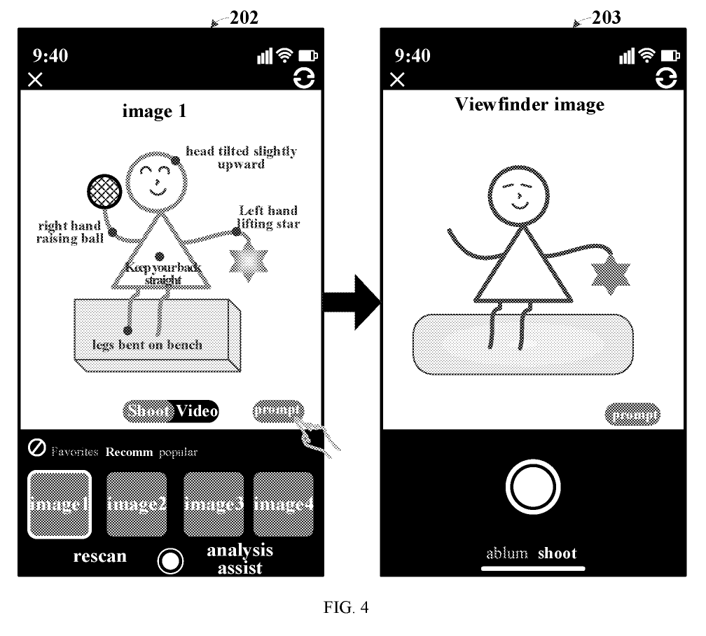

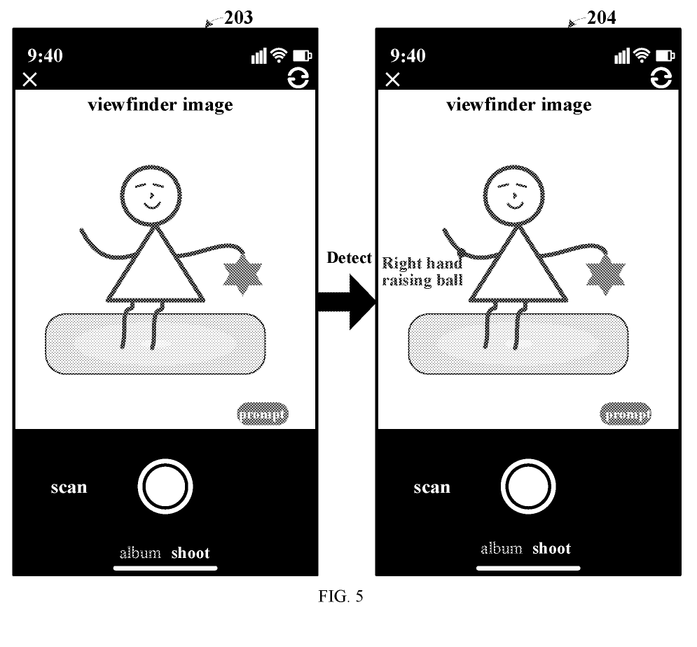

In this way, for a viewfinder image being displayed on the shooting interface (such as the viewfinder image shown on the shooting interface 203 in FIGS. 4 or 5), after the viewfinder image has been detected based on the at least one posture shooting key point to obtain the detection result, it is possible to first determine, based on the detection result, a key point (such as a key point of "right hand raising ball" shown in the shooting interface 204 in FIG. 5) that exists in the at least one posture shooting key point but is not matched with the viewfinder image, so that the mismatched key point may represent an aspect that needs improvement for the person in the viewfinder image; and then update the shooting interface based on the mismatched key point, so that the updated shooting interface may highlight the mismatched key point, and the photographer may quickly know how to optimize the shooting through the updated shooting interface, thereby improving efficiency.

It should be noted that the above "highlight" refers to highlighting a certain content (such as the above mismatched key point), so that the user may easily notice the content, which is favorable for enhancing the user's focus on the content; and the present disclosure does not limit the implementation of the above "highlight", for example, it may be implemented by any way that may highlight some information, such as colored text, text presenting a dynamic change effect, or marking with a striking border.

In addition, in some scenarios, such as a scenario where no shooting key point is displayed on the viewfinder image, in order to better improve the shooting effect, the step of "updating the shooting interface based on the mismatched key point" may include: in response to detecting that the at least one posture shooting key point is not displayed on the viewfinder image (such as the viewfinder image shown in the shooting interface 203 in FIG. 5), adding and displaying a mismatched key point on the viewfinder image according to a position of a body part described by the mismatched key point in the viewfinder image, so that the mismatched key point may be highlighted by marking the mismatched key point at a corresponding position in the viewfinder image (such as the viewfinder image shown in the shooting interface 204 in FIG. 5), and the photographer may quickly find out where the issue is in the viewfinder image, so as to improve the efficiency of finding and solving the issue, thereby improving the shooting efficiency.

In this way, for a viewfinder image being displayed on the shooting interface (such as the viewfinder image shown in the shooting interface 203 in FIG. 5), if the at least one posture shooting key point is not displayed on the viewfinder image, after the viewfinder image has been detected based on the at least one posture shooting key point to obtain the detection result, a key point (such as the key point of "right hand raising ball" shown in the shooting interface 204 in FIG. 5) that is indicated by the detection result but is not matched with the viewfinder image may be directly added and displayed at a corresponding position in the viewfinder image, so that the photographer may quickly find out where the issue is in the viewfinder image from the viewfinder image, so as to improve the efficiency of finding and solving the issue, thereby improving the shooting efficiency.

It should be noted that the present disclosure does not limit the acquisition manner of the above "position of the body part described by the mismatched key point in the viewfinder image", for example, the position may be obtained by processing the mismatched key point (or a feature vector of the mismatched key point) and the viewfinder image with a pre-built machine learning model having a positioning function, so that the position may represent a marking position of the mismatched key point on the viewfinder image. In addition, the present disclosure does not limit the implementation of the machine learning model, for example, it may be implemented by a pre-built visual positioning model. The visual positioning model is used to predict a corresponding position of a piece of information (such as text) in an image.

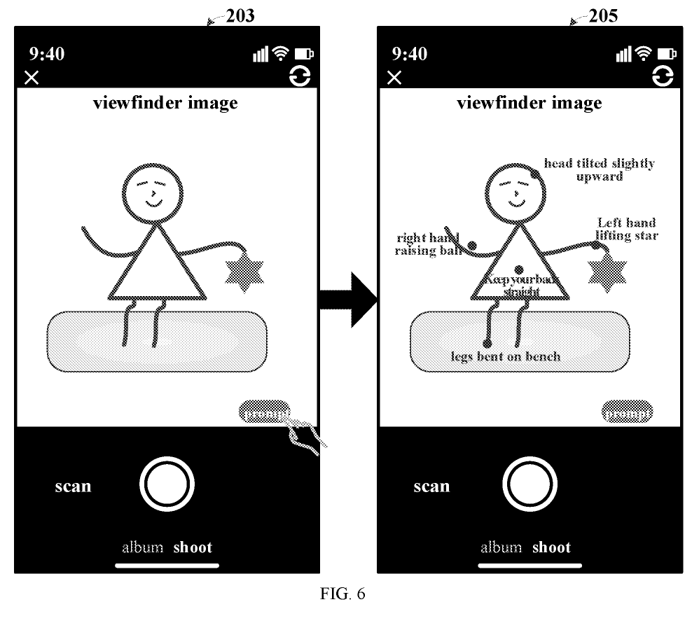

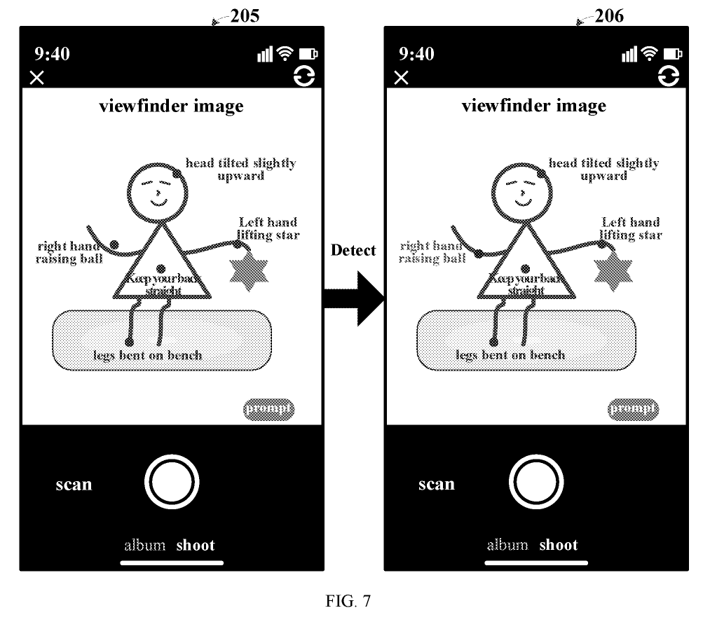

In addition, in some scenarios, such as a scene where each shooting key point is being displayed on the viewfinder image, in order to better improve the shooting effect, the step of "updating the shooting interface based on the mismatched key point" may include: in response to detecting that the at least one posture shooting key point is displayed on the viewfinder image (such as the viewfinder image shown in the shooting interface 205 in FIGS. 6 or 7), adjusting a display state of the mismatched key point on the viewfinder image, wherein a highlighting level of the display state after the adjustment (such as the display state of the key point of "right hand raising ball" shown in the shooting interface 206 in FIG. 7) is higher than a highlighting level of the display state before the adjustment (such as the display state of the key point of "right hand raising ball" shown in the shooting interface 205 in FIG. 7), so that the mismatched key point may be highlighted by adjusting the display state of the mismatched key point in the viewfinder image, therefore, the photographer may quickly find out where the issue is in the viewfinder image, so as to improve the efficiency of finding and solving the issue, thereby improving the shooting efficiency.

In this way, for the viewfinder image being displayed on the shooting interface (such as the viewfinder image shown in the shooting interface 205 in FIG. 7), if the at least one posture shooting key point is being displayed on the viewfinder image, after the viewfinder image has been detected based on the at least one posture shooting key point to obtain the detection result, the display state of the key point, that is indicated by the detection result and is not matched with the viewfinder image, on the viewfinder image may be adjusted to a highlight state (such as the display state of the key point of "right hand raising ball" shown in the shooting interface 206 in FIG. 7), so that the mismatched key point is more conspicuous, therefore, the photographer may quickly find out where the issue is in the viewfinder image, so as to improve the efficiency of finding and solving the issue, thereby improving the shooting efficiency.

It should be noted that for the "display state" illustrated in the above two paragraphs, the display state may describe a state presented when a shooting key point is displayed on the viewfinder image, such as a text color state, a font size state, etc. In addition, the present disclosure does not limit the implementation of the display state.

It should also be noted that the present disclosure does not limit a control manner of whether to display the at least one posture shooting key point on the viewfinder image, for example, the control manner may be implemented with a control that is deployed on the shooting interface and has the control function (such as a prompt button shown in the shooting interface 203 in FIG. 6). For another example, the control manner may also be implemented by some preset trigger operations (such as a left slide operation triggered in the viewfinder image).

The research has found that in some scenarios, for example, a scenario where details of a person's posture are difficult to understand or find, the photographer may not know how to improve a person in the current viewfinder image to present the posture of the person in the reference image, which may affect the shooting effect, such as shooting quality, shooting efficiency, etc.

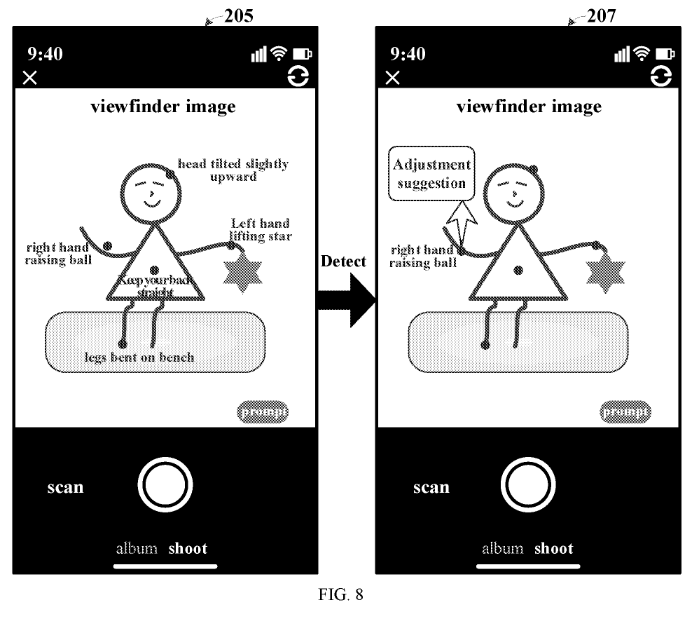

Based on the above research, in order to better improve the shooting effect, the step of "updating the shooting interface based on the mismatched key point" may include: adding and displaying suggestion information (such as the adjustment suggestion shown in the shooting interface 207 in FIG. 8) corresponding to the mismatched key point on the shooting interface, the suggestion information describes an adjustment process of a body part described by the mismatched key point changing from a posture in the viewfinder image to a posture indicated by the mismatched key point, so that the photographer may better know how to optimize the current viewfinder image from the adjustment suggestion, thereby being favorable for better improving the shooting effect, such as improving the shooting efficiency and improving the shooting quality.

In this way, for a viewfinder image being displayed on the shooting interface (such as the viewfinder image shown on the shooting interface 205 in FIG. 8), after the viewfinder image has been detected based on the at least one posture shooting key point to obtain the detection result, it is possible to first determine, according to a key point that is indicated by the detection result and is not matched with the viewfinder image, the suggestion information (such as the adjustment suggestion shown in the shooting interface 207 in FIG. 8) corresponding to the mismatched key point, so that the suggestion information may indicate how to adjust a body part described by the mismatched key point from a posture in the viewfinder image (such as a right hand state shown in the shooting interface 205 in FIG. 8) to a posture indicated by the mismatched key point (such as a right hand state shown in the shooting interface 201 in FIG. 2), and the photographer may quickly know how to optimize the current viewfinder image from the adjustment suggestion, thereby improving an optimization effect, which is favorable for better improving the shooting effect.

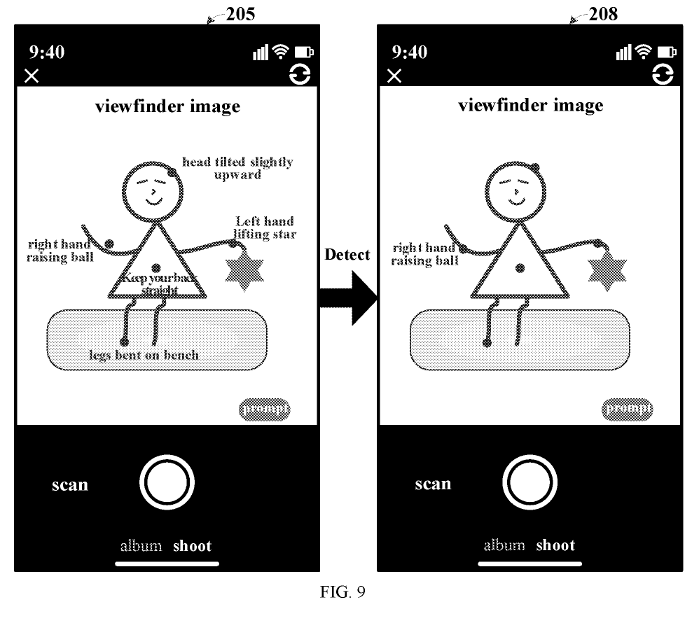

The research has found that in some scenarios, such as a scenario where shooting key points are being displayed on the viewfinder image, in order to avoid interference caused by a matched key point, it is possible to weaken the photographer's focus on the matched key point by adjusting a display state of the matched key point, therefore, in order to better meet the above requirements, the step of "updating the shooting interface based on the detection result" in the above S3 may include: in response to detecting that the detection result indicates that there is a key point in the at least one posture shooting key point which is matched with the viewfinder image, updating the shooting interface based on the matched key point, wherein the matched key point is weakly displayed or not displayed on the updated shooting interface (such as the shooting interface 208 shown in FIG. 9), so that it is difficult for the photographer to directly view the matched key point through the updated shooting interface, which is favorable for reducing interference caused by the matched key point to the photographer, and further favorable for prompting the photographer to more focus on the mismatched key point, thereby being favorable for better improving the shooting effect.

In this way, for the viewfinder image being displayed on the shooting interface (such as the viewfinder image shown on the shooting interface 205 in FIG. 9), if the at least one posture shooting key point is being displayed on the viewfinder image, after the viewfinder image has been detected based on the at least one posture shooting key point to obtain the detection result, it is possible to first determine, based on the detection result, a key point in the at least one posture shooting key point that is matched with the viewfinder image, so that the matched key point may represent an aspect in the viewfinder image where a person does not need to be improved; and then update the shooting interface according to the matched key point, so that the updated shooting interface may display the matched key point weakly (for example, the weak display realized by turning off the bubbles as shown in the shooting interface 208 in FIG. 9) or does not display the matched key point, so that the photographer may ignore the matched key point through the updated shooting interface, which is further favorable for prompting the photographer to more focus on the mismatched key point (such as the key point of "right hand raising ball" shown in the shooting interface 208 in FIG. 9), thereby being favorable for better improving the shooting effect.

The research has found that in some scenarios, such as a scenario where there is a mismatched key point, etc., the user may have a need to "view the reference image again" during shooting, so that the user may confirm whether the viewfinder image is good enough by comparing the viewfinder image with the reference image. Example 1, if the current viewfinder image does not match some shooting key points, the photographer may want to view the reference image again, in order to more accurately know the issues existing in the current viewfinder image and how to optimize the viewfinder image through the reference image. Example 2, if the current viewfinder image matches some shooting key points, the photographer may want to view the reference image again, in order to more accurately know whether these matched aspects still need to be tuned finely to overcome a slight difference between the viewfinder image and the reference image.

Based on the above research, in order to better meet the above needs, the present disclosure further provides a possible implementation of the interaction method, and in this implementation, the interaction method may further include: after the step of "updating the shooting interface based on the detection result", in response to detecting an operation of displaying the reference image that is triggered on the shooting interface (such as an operation of clicking an image prompt button shown in the shooting interface 209 in FIG. 10), displaying a thumbnail (such as a thumbnail 211 shown in the shooting interface 210 in FIG. 10) of the reference image at a preset position in the viewfinder image, so that the photographer may better know how to better optimize the viewfinder image by comparing the viewfinder image with the thumbnail, thereby facilitating better shooting of a high-quality image.

In this way, for the viewfinder image being displayed on the shooting interface, after the viewfinder image has been detected based on the at least one posture shooting key point to obtain the detection result, the shooting interface is first updated according to the detection result, so that the matching status between the viewfinder image and the shooting key points is displayed on the updated shooting interface (such as the shooting interface 209 shown in FIG. 10), so that when the operation of displaying the reference image that is triggered on the updated shooting interface (such as the operation of clicking the image prompt button shown in the shooting interface 209 in FIG. 10) is detected, a thumbnail of the reference image is added and displayed at the preset position of the viewfinder image, so that the photographer may view both the thumbnail and the viewfinder image concurrently, and the photographer may better know how to better optimize the viewfinder image by comparing the viewfinder image with the thumbnail, which is favorable for better shooting of high-quality images.

It should be noted that for the preset position illustrated in the above two paragraphs, the preset position refers to a display position of the thumbnail of the reference image, and the present disclosure does not limit the implementation of the preset position, for example, it may be implemented with a pre-fixed position (such as a lower left corner position in the viewfinder image). For another example, in some scenarios (such as a scenario focusing on the above mismatched key point), in order to better perform comparison, the preset position may be determined based on the position of the body part described by the mismatched key point in the viewfinder image, to ensure that a distance between the preset position and the "position of the body part described by the mismatched key point in the viewfinder image" is less than a preset distance, so that it may be effectively ensured that the thumbnail is displayed around the mismatched key point, thereby favorable for more convenient comparison between the viewfinder image and the thumbnail, and further favorable for better shooting of high-quality images.

It should also be noted that for the thumbnail of the reference image illustrated in the above three paragraphs, the thumbnail may describe information carried by the reference image with a smaller image size, so that the thumbnail may occupy a smaller area to present the information carried by the reference image, thereby being favorable for reducing the occlusion for the viewfinder image, and further being favorable for better overcoming the problems caused by the occlusion.

It should be further noted that for the above "operation of displaying the reference image that is triggered on the shooting interface", the operation requests to add and display the reference image on the shooting interface; and the present disclosure does not limit the implementation of the operation, for example, it may be implemented by some preset trigger operations (for example, a right slide operation triggered on the viewfinder image). For another example, it may be implemented with a click operation triggered on a control (such as the image prompt button shown in the shooting interface 209 in FIG. 10) that is deployed on the shooting interface and has the function of adding and displaying the reference image. The image prompt button may control whether to add and display the reference image on the viewfinder image in a certain manner (such as a thumbnail manner shown in FIG. 10); and a key point prompt button in the shooting interface 209 may control whether to add and display the at least one posture shooting key point extracted from the reference image on the viewfinder image.

It should be further noted that for the control (such as the above image prompt button) having the function of adding and displaying the reference image illustrated in the previous paragraph, the present disclosure does not limit a display timing of the control, for example, the control may be displayed when the content displayed in a display area of the shooting interface is switched from the reference image to the viewfinder image. For another example, in some scenarios (such as a scenario focusing on the above mismatched key point), a display flow of the control may be: in response to detecting that the detection result indicates that there is a key point in the at least one posture shooting key point that is not matched with the viewfinder image, adding and displaying the control on the shooting interface, so that the photographer may subsequently use the control to meet a need of viewing the reference image.

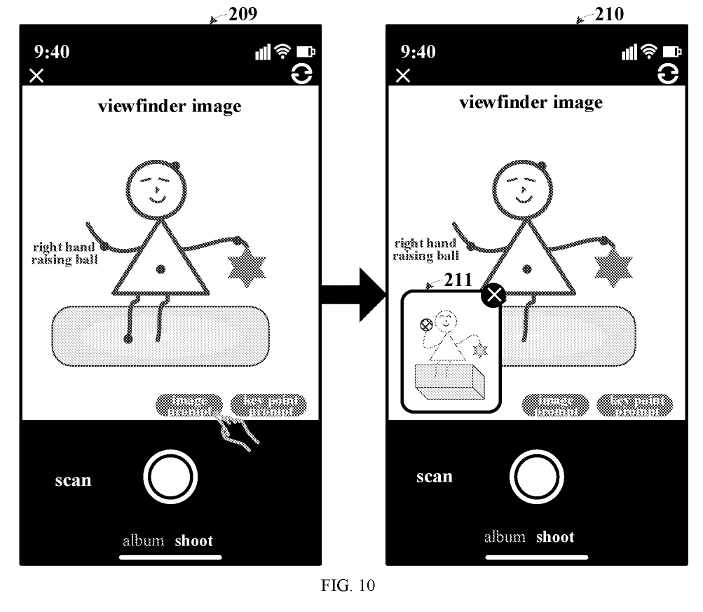

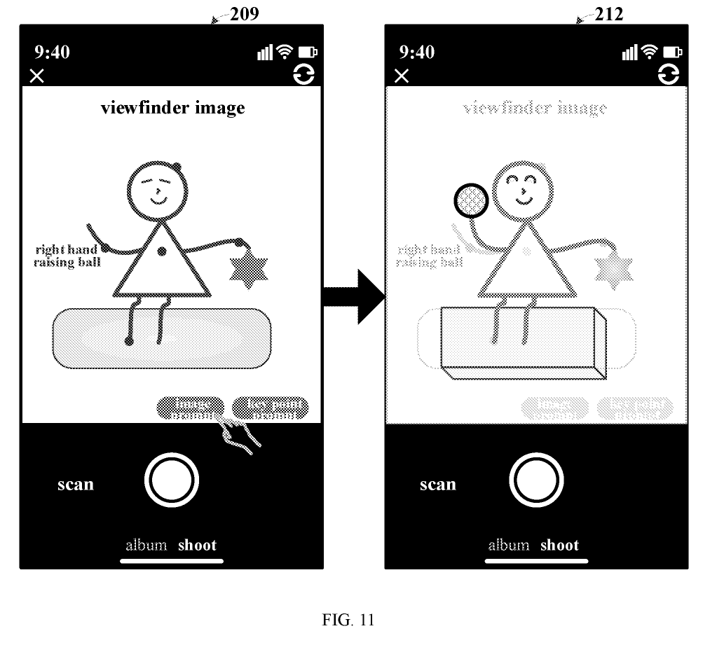

In addition, in some scenarios, such as a scenario where a person's posture in the reference image is complex or a scene where a person's posture in the reference image needs to be restored as accurately as possible, in order to better improve an image shooting effect, the present disclosure further provides a possible implementation of the interaction method, and in this implementation, the interaction method may further include: after the step of "updating the shooting interface based on the detection result", in response to detecting an operation of displaying the reference image that is triggered on the shooting interface (such as an operation of clicking an image prompt button shown in the shooting interface 209 in FIG. 11), adding and displaying a transparent layer (such as a transparent layer shown in the shooting interface 212 in FIG. 11) on the viewfinder image, the transparent layer is displayed with the reference image, so that the photographer may see both the reference image and the viewfinder image concurrently, and the photographer may better know how to optimize the viewfinder image by comparing the viewfinder image with the reference image, which is favorable for better shooting of high-quality images.

In this way, for the viewfinder image being displayed on the shooting interface, after the viewfinder image has been detected based on the at least one posture shooting key point to obtain the detection result, the shooting interface is first updated based on the detection result, so that the matching status between the viewfinder image and the shooting key points is displayed on the updated shooting interface (such as the shooting interface 209 shown in FIG. 11), therefore, when the operation of displaying the reference image that is triggered on the updated shooting interface (such as the operation of clicking the image prompt button shown in the shooting interface 209 in FIG. 11) is detected, the transparent layer (such as a mask) for carrying the reference image is added and displayed above the viewfinder image, so that the photographer may see both the reference image and the viewfinder image concurrently, and the photographer may better know how to optimize the viewfinder image by comparing the viewfinder image with the reference image, which is favorable for better shooting of high-quality images. By means of the transparent layer, the person in the reference image and the person in the viewfinder image may be aligned to some extent, so that the photographer may more accurately know what issues exist in the current viewfinder image and how to solve the issues based on the alignment result, which is favorable for better improving the shooting effect.

It should be noted that the present disclosure does not limit the implementation of the transparent layer illustrated in the above two paragraphs, for example, it may be implemented with any layer having a certain transparency (such as a semi-transparent layer). For another example, in order to better improve a comparison effect, the transparent layer may at least meet the following constraint: a bounding box for a person in the reference image displayed on the transparent layer is completely aligned with a bounding box for the person in the viewfinder image, so that the person alignment between the two images may be realized as much as possible, which is favorable for better representing the difference between postures presented by different body parts in the viewfinder image and ideal postures described by the reference image, and further enabling the photographer to more accurately know what issues exist in the current viewfinder image and how to solve the issues, thereby being favorable for better improving the shooting effect.

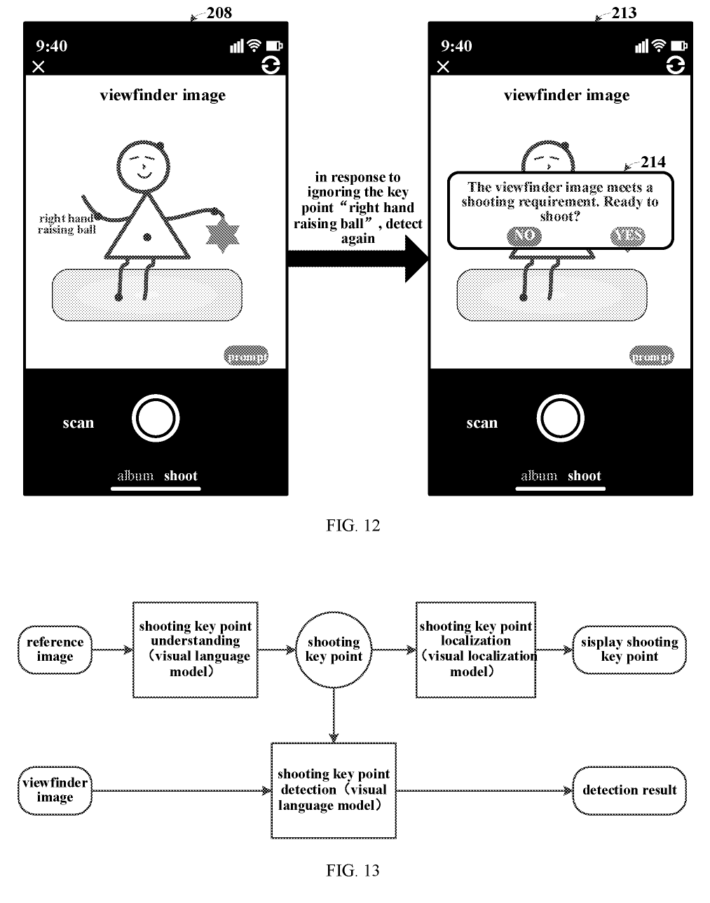

The research has found that in some scenarios, some shooting key points may not be achieved or are difficult to achieve, therefore, in order to avoid the impact of the above shooting key points on shooting, the present disclosure further provides a possible implementation of the interaction method, and in this implementation, when a key point in the at least one posture shooting key point that is not matched with the viewfinder image is displayed on the above updated shooting interface (such as the shooting interface 208 shown in FIG. 12), the interaction method may further include: in response to detecting that an operation of ignoring the mismatched key point is triggered on the updated shooting interface, updating the detection result, wherein the updated detection result indicates that the mismatched key point is in a matching state with the viewfinder image, or the updated detection result indicates that there is no the mismatched key point in the at least one posture shooting key point, and continuing to perform the above step of “updating the shooting interface based on the detection result” and subsequent steps, so that the shooting difficulty may be reduced by manually ignoring some mismatched key points, thereby being favorable for better improving the shooting experience.

In this way, in a possible implementation, the photographing process provided by the present disclosure includes: for the shooting interface being displayed, if it is detected the operation of acquiring the reference image is triggered on the shooting interface, detecting, based on the at least one posture shooting key point extracted from the reference image, the viewfinder image displayed on the shooting interface to obtain the detection result, and updating the shooting interface based on the detection result, so that the key point that exists in the at least one posture shooting key point and is not matched with the viewfinder image is displayed on the updated shooting interface (such as the shooting interface 208 shown in FIG. 12), when it is detected that an operation of ignoring the mismatched key point is triggered on the updated shooting interface, updating the detection result, wherein the updated detection result indicates that the mismatched key point is in a matching state with the viewfinder image, or the updated detection result indicates that there is no the mismatched key point in the at least one posture shooting key point, therefore, the updated detection result no longer indicates that the current viewfinder image cannot meet the mismatched key point, and returning to continue to perform the above step of “updating the shooting interface based on the detection result” and subsequent steps, so that the shooting difficulty may be reduced by manually ignoring some mismatched key points, thereby being favorable for better improving the shooting experience.

It should be noted that for the "operation of ignoring the mismatched key point" illustrated in the above two paragraphs, the operation requests not to use the mismatched key point to guide shooting, and the present disclosure does not limit the implementation of the operation, for example, it may be implemented by any way that may delete content from a page (for example, first long press the mismatched key point to reveal a delete button for the mismatched key point; and then click the delete button, etc.).

The research has found that in order to better improve the shooting effect, the shooting may be completed by multiple rounds of iteration. Based on this, the present disclosure further provides a possible implementation of the interaction method, and in this implementation, the interaction method may further include: after the step of "updating the shooting interface based on the detection result", in response to detecting that the detection result indicates that there is a key point in the at least one posture shooting key point that is not matched with the viewfinder image, returning to continue to perform the step of "detecting, based on the at least one posture shooting key point, the viewfinder image displayed on the shooting interface to obtain the detection result" and subsequent steps, so that a multi-round optimization process may be implemented for the viewfinder image under the guidance of these shooting key points, which is favorable for better shooting of high-quality images.

In this way, in a possible implementation, the photographing process provided by the present disclosure includes: for the shooting interface being displayed, if it is detected the operation of acquiring the reference image is triggered on the shooting interface, detecting, based on the at least one posture shooting key point extracted from the reference image, the viewfinder image displayed on the shooting interface to obtain the detection result, and updating the shooting interface based on the detection result, so that when it is determined that the updated shooting interface (or the detection result) indicates that there is a key point in the at least one posture shooting key point that is not matched with the viewfinder image, returning to continue to perform the step of "detecting, based on the at least one posture shooting key point extracted from the reference image, the viewfinder image displayed on the shooting interface to obtain the detection result" and subsequent steps, to implement the next round of processing, so that high-quality images may be better shot through multiple rounds of iteration.

In addition, in order to better improve the shooting experience, the present disclosure further provides a possible implementation of the interaction method, and in this implementation, when the interaction method is implemented by the multiple rounds of iteration illustrated in the above two paragraphs, the interaction method may further include: in response to detecting that a duration in which the mismatched key point is in a mismatching state with the viewfinder image reaches a preset duration, updating the detection result, wherein the updated detection result indicates that the mismatched key point is in a matching state with the viewfinder image or the updated detection result indicates that there is no the mismatched key point in the at least one posture shooting key point, and returning to continue to perform the step of "updating the shooting interface based on the detection result" and subsequent steps, so that the shooting difficulty may be reduced by automatically ignoring some mismatched key points, thereby being favorable for better improving the shooting experience.

In this way, in a possible implementation, the photographing process provided by the present disclosure includes: for the shooting interface being displayed, if it is detected the operation of acquiring the reference image is triggered on the shooting interface, detecting, based on the at least one posture shooting key point extracted from the reference image, the viewfinder image displayed on the shooting interface to obtain the detection result, and updating the shooting interface based on the detection result, so that when it is determined that the updated shooting interface (or the detection result) indicates that there is a key point in the at least one posture shooting key point that is not matched with the viewfinder image, returning to continue to perform the step of "detecting, based on the at least one posture shooting key point extracted from the reference image, the viewfinder image displayed on the shooting interface to obtain the detection result" and subsequent steps, to implement the next round of processing, so that the iteration loops until it is determined that a duration in which the mismatched key point is in a mismatching state with the viewfinder image reaches a preset duration, it may be determined that the shot object may be difficult to meet the mismatched key point, therefore, in order to reduce the shooting difficulty, the detection result is updated, so that the updated detection result indicates that the mismatched key point is in the matching state with the viewfinder image (or the updated detection result indicates that there is no mismatched key point in the at least one posture shooting key point), and the updated detection result no longer indicates that the current viewfinder image cannot meet the mismatched key point, and returning to continue to perform the step of "updating the shooting interface based on the detection result" and subsequent steps, so that the shooting difficulty may be reduced by automatically ignoring some mismatched key points, thereby being favorable for better improving the shooting experience.

In addition, in order to better improve the shooting experience, the step of "in response to detecting that a duration in which the mismatched key point is in a mismatching state with the viewfinder image reaches a preset duration, updating the detection result" may include: in response to detecting that the duration in which the mismatched key point is in the mismatching state with the viewfinder image reaches the preset duration, displaying preset information on the shooting interface, wherein the preset information inquires whether to ignore the mismatched key point; in response to detecting that a trigger operation for the preset information indicates to ignore the mismatched key point, updating the detection result, so that the shooting difficulty may be reduced by ignoring some mismatched key points in a manner of inquiring the photographer, thereby being favorable for better improving the shooting experience.

In this way, in a possible implementation, the photographing process provided by the present disclosure includes: for the shooting interface being displayed, if it is detected the operation of acquiring the reference image is triggered on the shooting interface, detecting, based on the at least one posture shooting key point extracted from the reference image, the viewfinder image displayed on the shooting interface to obtain the detection result, and updating the shooting interface based on the detection result, so that when it is determined that the updated shooting interface (or the detection result) indicates that there is a key point in the at least one posture shooting key point that is not matched with the viewfinder image, returning to continue to perform the step of "detecting, based on the at least one posture shooting key point extracted from the reference image, the viewfinder image displayed on the shooting interface to obtain the detection result" and subsequent steps, to implement the next round of processing, so that the iteration loops until it is determined that a duration in which the mismatched key point is in a mismatching state with the viewfinder image reaches a preset duration, it may be determined that the shot object may be difficult to meet the mismatched key point, and the preset information may be displayed on the shooting interface, so that the preset information may inquire the photographer whether to ignore the mismatched key point, so that when it is detected that an operation triggered by the photographer for the preset information may indicate to ignore the mismatched key point, it may be confirmed that the shot object really cannot meet the mismatched key point, therefore, the detection result may be directly updated, so that the updated detection result indicates that the mismatched key point is in the matching state with the viewfinder image (or the updated detection result indicates that there is no mismatched key point in the at least one posture shooting key point), and the updated detection result no longer indicates that the current viewfinder image cannot meet the mismatched key point, and returning to continue to perform the step of "updating the shooting interface based on the detection result" and subsequent steps, so that the shooting difficulty may be reduced by ignoring some mismatched key points in a manner of inquiring the photographer, thereby being favorable for better improving the shooting experience.

In addition, in order to better improve the shooting experience, the step of "updating the shooting interface based on the detection result" in the above S3 may include: in response to detecting that the detection result indicates that each key point in the at least one posture shooting key point matches the viewfinder image, shooting the viewfinder image, or displaying prompt information (such as information in a pop-up window 214 shown in a shooting interface 213 in FIG. 12) on the shooting interface, where the prompt information indicates that the viewfinder image meets a shooting requirement, so that the photographer may know that the current viewfinder image may be shot based on the prompt information, so that a shooting timing may be flexibly determined based on such shooting key points, thereby being favorable for better shooting of high-quality images.

In this way, for the viewfinder image being displayed by the shooting interface in the current round, after acquiring the above detection result, if the detection result indicates that each key point in the at least one posture shooting key point matches the viewfinder image, it may be determined that the viewfinder image has already met all the key points, therefore, the user may be prompted to shoot or automatic shooting may be performed, which is favorable for better improving the shooting experience.

The research has found that in some scenarios, such as a selfie scenario, the user not only needs to pose as the shot object, but also needs to guide the entire shooting process as the photographer, which requires the user to continuously switch roles to perform corresponding operations during the shooting process, resulting in large shooting difficulty and low shooting efficiency.

Based on the above research, in order to solve the above problems, the present disclosure further provides a possible implementation of the interaction method, and in this implementation, when the interaction method is applied to an electronic device, the interaction method may further include: synchronizing a shooting interface to a display device, so that the shooting interface displayed on the display device is consistent with a shooting interface displayed on the electronic device in real time. The display device is independent of the electronic device, so that the user may view, through the display device, the state and issues of the viewfinder image acquired by the electronic device when posing, thereby effectively avoiding the defects caused by the user having to continuously switch roles during the shooting process, and further being favorable for better improving the selfie effect.

It should be noted that the present disclosure does not limit an implementation of the above display device, for example, it may be implemented with any device (such as another electronic device) that may synchronize a shooting interface with the electronic device. For another example, in some scenes, the display device may meet at least the following constraint: an angle between an orientation of a screen of the display device and an orientation of a camera in the electronic device for acquiring the viewfinder image is less than a preset threshold, so that the screen and the camera face the same person as much as possible.

It should also be noted that the present disclosure does not limit a placement position of the display device, for example, the display device may be placed at a position where the user poses, so that the user may view relevant information of the viewfinder image acquired by the electronic device through the display device without moving. For another example, the display device may follow the user's face (or eyes), so that the display device may always be located directly in front of the face (or eyes), which may effectively avoid impacts (such as adding new mismatched key points, etc.) caused by a user turning the head when viewing the display device, thereby being favorable for better improving the shooting experience.

In addition, in some scenarios, such as a selfie scenario, in order to save costs, the present disclosure further provides a possible implementation of the interaction method, and in this implementation, the interaction method may further include: converting text data generated based on the detection result into speech data for playing, wherein the text data indicates a matching result between some or all (such as mismatched key points, etc.) of the at least one posture shooting key point and the viewfinder image; or, converting some or all (such as mismatched key points, etc.) of the updated shooting interface into speech data for playing, so that the user may know from the speech data what issues exist in the current viewfinder image, so that the user taking a selfie may be guided to adjust the posture by means of voice playback, thereby effectively avoiding the defects caused by the user having to continuously switch roles during the shooting process, and further being favorable for better improving the selfie effect.

In addition, in order to better improve the shooting experience, the present disclosure further provides a possible implementation of the interaction method, and in this implementation, the interaction method may at least include the following steps 11-14.

Step 11: displaying a shooting interface (such as the shooting interface 200 shown in FIG. 2), so that a viewfinder image is displayed in a display area of the shooting interface.

It should be noted that for the relevant content of step 11, reference may be made to the relevant content of the above S1.

Step 12: in response to detecting an operation of acquiring a reference image that is triggered on the shooting interface (such as an operation of selecting the image 1 shown in the shooting interface 201 in FIG. 2), displaying the reference image in a display area of the shooting interface (such as the shooting interface 201 shown in FIG. 2).

It should be noted that for the relevant content of step 12, reference may be made to the relevant content of the above S2. In this way, in a possible implementation, for the electronic device, after the shooting interface (such as the shooting interface 200 shown in FIG. 2) is opened on the electronic device, some information (such as information about a shooting environment, etc.) is first collected through a scanning button deployed on the shooting interface; and then some candidate images are recommended based on the information (such as images 1 to 4 shown in the shooting interface 201 in FIG. 2, or images under the title “collection” shown in the shooting interface 201, or images under the title “popular” shown in the shooting interface 201, etc.), so that an image (such as the image 1 shown in FIG. 2) selected by the user from these candidate images may be displayed in the display area for the user to view subsequently.

Step 13: in response to detecting an operation of analyzing the reference image that is triggered on the shooting interface (such as an operation of clicking an analysis assistance button shown in the shooting interface 201 in FIG. 3), analyzing the reference image to obtain the at least one posture shooting key point, and adding and displaying each posture shooting key point on the reference image (such as content added in the shooting interface 202 in FIG. 3 relative to the shooting interface 201 in FIG. 3), according to a position of a body part described by each posture shooting key point in the reference image.

The above "operation of analyzing the reference image" requests to perform shooting key point analysis on the reference image, and the present disclosure does not limit an implementation of the "operation of analyzing the reference image".

In addition, the present disclosure does not limit the implementation of the analysis in the above step 13, for example, it may be implemented with a pre-built visual language model having a shooting key point understanding function, as shown in FIG. 13.

In addition, the present disclosure does not limit a determination process of "position of a body part described by each posture shooting key point in the reference image" in the above step 13, for example, it may be: for any posture shooting key point, after the posture shooting key point has been analyzed from the reference image, determining a position corresponding to the posture shooting key point in the reference image with a pre-built machine learning model (such as the visual positioning model shown in FIG. 13), as the position of the body part described by the posture shooting key point in the reference image, so that the posture shooting key point may be marked on the reference image according to the position subsequently.

Step 14: in response to detecting an operation of displaying a viewfinder image that is triggered on the shooting interface (such as an operation of clicking a prompt button shown in the shooting interface 202 in FIG. 4), displaying the viewfinder image (such as the viewfinder image shown in the shooting interface 203 in FIG. 4) in the display area of the shooting interface, detecting, based on the at least one posture shooting key point, the viewfinder image displayed on the shooting interface to obtain a detection result, the detection result includes a matching result between each key point in the at least one posture shooting key point and the viewfinder image, and updating the shooting interface based on the detection result, different posture shooting key points describe different body parts.

It should be noted that for the relevant content of step 14, reference may be made to the relevant content of the above S2.

It may be seen from the relevant content of the above steps 11 to 14 that in some scenarios, the process of selecting the reference image, the process of extracting the shooting key point from the reference image, and the process of guiding shooting based on the shooting key point may be implemented by means of interaction operations between the user and the electronic device, which is favorable for better meeting the user requirements in different stages, thereby being favorable for better improving the user experience.

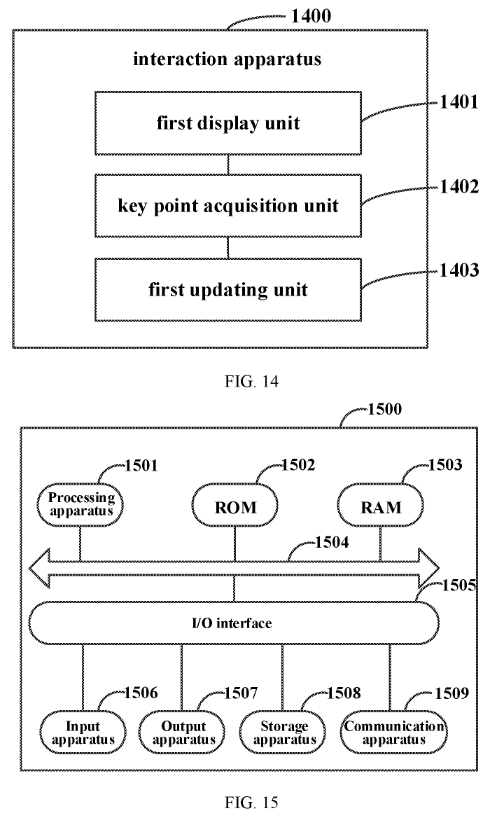

Based on the interaction method provided by the embodiments of the present disclosure, the embodiments of the present disclosure further provide an interaction apparatus, which will be explained and described below with reference to FIG. 14. FIG. 14 is a schematic structural diagram of an interaction apparatus provided by the embodiments of the present disclosure. It should be noted that for the technical details of the interaction apparatus provided by the embodiments of the present disclosure, reference may be made to the relevant content of the interaction method mentioned above.

As shown in FIG. 14, the interaction apparatus 1400 provided by the embodiments of the present disclosure includes:

a first display unit 1401, configured to display a shooting interface;

a key point acquisition unit 1402, configured to, in response to it is detected an operation of acquiring a reference image is triggered on the shooting interface, acquire at least one posture shooting key point from the reference image, where different posture shooting key points describe different body parts;

a first updating unit 1403, configured to detect, based on the at least one posture shooting key point, a viewfinder image displayed on the shooting interface to obtain a detection result, where the detection result includes a matching result between each key point in the at least one posture shooting key point and the viewfinder image, and update the shooting interface based on the detection result, different posture shooting key points describe different body parts.

In a possible implementation, the first updating unit 1403 is further configured to: in response to it is detected that the detection result indicates that there is a key point in the at least one posture shooting key point which is mismatched with the viewfinder image, update the shooting interface based on the mismatched key point, wherein the mismatched key point is highlighted on the updated shooting interface.

In a possible implementation, the first updating unit 1403 is further configured to: in response to it is detected that the at least one posture shooting key point is displayed on the viewfinder image, adjust a display state of the mismatched key point on the viewfinder image, wherein a highlighting level of the display state after the adjustment is higher than a highlighting level of the display state before the adjustment; and/or, in response to it is detected that the at least one posture shooting key point is not displayed on the viewfinder image, add and display the mismatched key point on the viewfinder image according to a position of the body part described by the mismatched key point in the viewfinder image

In a possible implementation, the first updating unit 1403 is further configured to: add and display suggestion information corresponding to the mismatched key point on the shooting interface, wherein the suggestion information describes an adjustment process of changing from a posture of the body part described by the mismatched key point in the viewfinder image to a posture indicated by the mismatched key point.

In a possible implementation, the interaction apparatus 1400 further includes a second display unit configured to, after the shooting interface has been updated based on the detection result, in response to it is detected that an operation of displaying the reference image is triggered on the shooting interface, display a thumbnail of the reference image at a preset position in the viewfinder image, or add and display a transparent layer on the viewfinder image, wherein the reference image is displayed on the transparent layer.

In a possible implementation, the updated shooting interface displays a key point in the at least one posture shooting key point that is mismatched with the viewfinder image; and the interaction apparatus 1400 further includes a second updating unit configured to, in response to it is detected that an operation of ignoring the mismatched key point is triggered on the updated shooting interface, update the detection result, wherein the updated detection result indicates that the mismatched key point is in a matching state with the viewfinder image, or the updated detection result indicates that there is no the mismatched key point in the at least one posture shooting key point, and return to the first updating unit 1403 to continue to perform the step of updating the shooting interface based on the detection result.

In a possible implementation, the interaction apparatus 1400 further includes a first processing unit configured to, after the shooting interface has been updated based on the detection result, in response to it is detected that the detection result indicates that there is a key point in the at least one posture shooting key point which is mismatched with the viewfinder image, return to the first updating unit 1403 to continue to perform the step of detecting, based on the at least one posture shooting key point, the viewfinder image displayed on the shooting interface to obtain the detection result.

In a possible implementation, the interaction apparatus 1400 further includes a third updating unit configured to, in response to it is detected that a duration in which the mismatched key point is in a mismatching state with the viewfinder image reaches a preset duration, update the detection result, wherein the updated detection result indicates that the mismatched key point is in a matching state with the viewfinder image or the updated detection result indicates that there is no the mismatched key point in the at least one posture shooting key point, and return to the first updating unit 1403 to continue to perform the step of updating the shooting interface based on the detection result.

In a possible implementation, the third updating unit is specifically configured to: in response to it is detected that the duration in which the mismatched key point is in the mismatching state with the viewfinder image reaches the preset duration, display preset information on the shooting interface, wherein the preset information inquires whether to ignore the mismatched key point; and in response to it is detected that a trigger operation for the preset information indicates to ignore the mismatched key point, update the detection result

In a possible implementation, the first updating unit 1403 is specifically configured to: in response to it is detected that the detection result indicates that there is a key point in the at least one posture shooting key point which is matched with the viewfinder image, update the shooting interface based on the matched key point, wherein the matched key point is weakly displayed or not displayed on the updated shooting interface.

In a possible implementation, the first updating unit 1403 is specifically configured to: in response to it is detected that the detection result indicates that each key point in the at least one posture shooting key point is matched with the viewfinder image, shoot the viewfinder image, or display prompt information on the shooting interface, wherein the prompt information indicates that the viewfinder image meets a shooting requirement.

In a possible implementation, the interaction apparatus 1400 further includes a data synchronization unit configured to synchronize the shooting interface to a display device, wherein the display device is independent of the interaction apparatus 1400.

In a possible implementation, the interaction apparatus 1400 further includes a voice broadcast unit configured to, convert text data generated based on the detection result into speech data for playing, wherein the text data indicates a matching result between some or all of the at least one posture shooting key point and the viewfinder image; or, convert some or all of the updated shooting interface into speech data for playing.

In a possible implementation, the key point acquisition unit 1402 is specifically configured to: in response to it is detected that the operation of acquiring the reference image is triggered on the shooting interface, display the reference image in a display area of the shooting interface; in response to it is detected that an operation of analyzing the reference image is triggered on the shooting interface, analyze the reference image to obtain the at least one posture shooting key point, and add and display each posture shooting key point on the reference image according to a position of a body part described by each posture shooting key point in the reference image;

the first updating unit 1403 is specifically configured to: in response to it is detected that an operation of displaying the viewfinder image is triggered on the shooting interface, display the viewfinder image in the display area, and detect, based on the at least one posture shooting key point, the viewfinder image displayed on the shooting interface to obtain the detection result.

It may be seen from the relevant content of the above interaction apparatus 1400 that the working principle of the apparatus 1400 includes: for a shooting interface being displayed, if it is detected that an operation of acquiring a reference image (such as a high aesthetic image) is triggered on the shooting interface, at least one posture shooting key point, for example, key point such as "head tilted slightly upward", "hand supporting a colorful umbrella", and "legs bent on bench", is first acquired from the reference image; and then a viewfinder image displayed on the shooting interface is detected based on the at least one posture shooting key point to obtain a detection result, so that the detection result includes a matching result between each key point in the at least one posture shooting key point and the viewfinder image, and the detection result may indicate whether the current viewfinder image may meet these key points, then the shooting interface may be updated subsequently based on the detection result, the updated shooting interface may represent the detection result to some extent, and a photographer may know the deficiencies of the current viewfinder image from the updated shooting interface, so that the photographer may guide a shot object to adjust its posture based on the updated shooting interface subsequently, therefore, the shooting can be made under the guidance of such key points, and a high-quality image may be shot under the guidance of such key points, and thus is favorable for improving shooting experience. In addition, since different posture shooting key points describe different body parts, these key points may fully describe posture details described by the reference image, so that an image shot under the guidance of such key points may restore the posture described by the reference image as much as possible, which is further favorable for better improving the shooting quality.

In addition, an embodiment of the present disclosure further provides an electronic device, including a processor and a memory, where the memory is configured to store instructions or a computer program, and the processor is configured to execute the instructions or the computer program in the memory to cause the electronic device to perform any implementation of the interaction method provided by the embodiments of the present disclosure.

Referring to FIG. 15, it shows a schematic structural diagram of an electronic device 1500 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable media player (PMP), and an in-vehicle terminal (such as an in-vehicle navigation terminal), and fixed terminals such as a digital TV and a desktop computer. The electronic device shown in FIG. 15 is only an example, and should not impose any limitation on the function and scope of use of the embodiments of the present disclosure.

As shown in FIG. 15, the electronic device 1500 may include a processing apparatus (such as a central processing unit, a graphics processor, etc.) 1501, which may perform various appropriate actions and processes according to a program stored in a read-only memory (ROM) 1502 or a program loaded from a storage apparatus 1508 into a random-access memory (RAM) 1503. In the RAM 1503, various programs and data required for the operation of the electronic device 1500 are also stored. The processing apparatus 1501, the ROM 1502 and the RAM 1503 are connected to each other through a bus 1504. An input/output (I/O) interface 1505 is also connected to the bus 1504.

Usually, the following apparatuses may be connected to the I/O interface 1505: an input apparatus 1506 including, for example, a touch screen, a touchpad, a keyboard, a mouse, a camera, a microphone, an accelerometer, a gyroscope, etc.; an output apparatus 1507 including, for example, a liquid crystal display (LCD), a speaker, a vibrator, etc.; a storage apparatus 1508 including, for example, a magnetic tape, a hard disk, etc.; and a communication apparatus 1509. The communication apparatus 1509 may allow the electronic device 1500 to perform wireless or wired communication with other devices to exchange data. Although FIG. 15 shows the electronic device 1500 with various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 1509, or installed from the storage apparatus 1508, or installed from the ROM 1502. When the computer program is executed by the processing apparatus 1501, the above-mentioned functions defined in the method of the embodiments of the present disclosure are executed.

The electronic device provided by the embodiment of the present disclosure belongs to the same inventive concept as the method provided by the above embodiment, and for the technical details not described in detail in this embodiment, reference may be made to the above embodiment, and this embodiment has the same beneficial effects as the above embodiment.

An embodiment of the present disclosure further provides a computer-readable medium, where instructions or a computer program are stored in the computer-readable medium, and the instructions or the computer program, when running on a device, cause the device to perform any implementation of the interaction method provided by the embodiments of the present disclosure.

It should be noted that the above computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program, which may be used by or in combination with an instruction execution system, apparatus, or device. In the present disclosure, a computer-readable signal medium may include a data signal propagated on a baseband or as a part of a carrier wave, and computer-readable program code is carried in the data signal. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, clients and servers may communicate using any currently known or future developed network protocol, such as the hyper text transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above computer-readable medium may be included in the above electronic device, or may exist alone without being assembled into the electronic device.

The above computer-readable medium carries one or more programs, which, when executed by the electronic device, cause the electronic device to perform the above method.

The computer program code for performing the operations of the present disclosure may be written in one or more programming languages or a combination thereof, the programming languages include, but are not limited to, object-oriented programming languages such as Java, Smalltalk, C++, and include conventional procedural programming languages such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the block may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or hardware. The name of the unit/module does not constitute a limitation on the unit itself under certain circumstances.

The functions described above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the various embodiments in this specification are described in a progressive manner, each embodiment focuses on the differences from other embodiments, and the same and similar parts between the various embodiments may be referred to each other. For the system or apparatus disclosed in the embodiments, since it corresponds to the method disclosed in the embodiments, the description is relatively simple, and for the relevant parts, reference may be made to the description of the method part.

It should be understood that in the present disclosure, "at least one (item)" refers to one or more, and "a plurality of" refers to two or more. "And/or" describes an association relationship between associated objects, and represents that three relationships may exist, for example, "A and/or B" may represent: only A exists, only B exists, and both A and B exist, where A and B may be singular or plural. The character "/" generally indicates that the associated objects before and after are in an "or" relationship. "At least one of the following" or a similar expression thereof refers to any combination of these items, including a single item or any combination of plural items. For example, at least one of a, b or c may represent: a, b, c, "a and b", "a and c", "b and c", or "a and b and c", where a, b and c may be single or plural.

It should also be noted that in this paper, relational terms such as first and second are only used to distinguish one entity or operation from another entity or operation, and do not necessarily require or imply any actual relationship or order between these entities or operations. Moreover, the terms "include", "comprise" or any other variant thereof are intended to cover non-exclusive inclusion, so that a process, method, object or device including a series of elements includes not only those elements, but also other elements not explicitly listed or elements inherent to such process, method, object or device. Without further restrictions, an element defined by the phrase "includes a" does not exclude the existence of other identical elements in the process, method, object or device including the element.

The steps of the method or algorithm described in combination with the embodiments disclosed herein may be directly implemented by hardware, a software module executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or any other form of storage medium known in the technical field.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but rather to the widest scope consistent with the principles and novel features disclosed herein.

What is claimed is:

1. An interaction method, comprising:
displaying a shooting interface;
in response to detecting an operation of acquiring a reference image that is triggered on the shooting interface, acquiring at least one posture shooting key point from the reference image, wherein different posture shooting key points describe different body parts; and
detecting, based on the at least one posture shooting key point, a viewfinder image displayed on the shooting interface to obtain a detection result, wherein the detection result comprises a matching result between each of the at least one posture shooting key point and the viewfinder image, and updating the shooting interface based on the detection result.

2. The method of claim 1, wherein, the updating the shooting interface based on the detection result comprises:
in response to detecting that the detection result indicates that there is a key point in the at least one posture shooting key point which is mismatched with the viewfinder image, updating the shooting interface based on the mismatched key point, wherein the mismatched key point is highlighted on the updated shooting interface.

3. The method of claim 2, wherein, the updating the shooting interface based on the mismatched key point comprises at least one of:
in response to detecting that the at least one posture shooting key point is displayed on the viewfinder image, adjusting a display state of the mismatched key point on the viewfinder image, wherein a highlighting level of the display state after the adjustment is higher than a highlighting level of the display state before the adjustment; or
in response to detecting that the at least one posture shooting key point is not displayed on the viewfinder image, adding and displaying the mismatched key point on the viewfinder image according to a position of the body part described by the mismatched key point in the viewfinder image; or
adding and displaying suggestion information corresponding to the mismatched key point on the shooting interface, wherein the suggestion information describes an adjustment process of changing from a posture of the body part described by the mismatched key point in the viewfinder image to a posture indicated by the mismatched key point.

4. The method of claim 1, wherein, after the updating the shooting interface based on the detection result, the method further comprises:
in response to detecting an operation of displaying the reference image that is triggered on the shooting interface, displaying a thumbnail of the reference image at a preset position in the viewfinder image, or adding and displaying a transparent layer on the viewfinder image, wherein the reference image is displayed on the transparent layer.

5. The method of claim 1, wherein, a key point in the at least one posture shooting key point, that is mismatched with the viewfinder image, is displayed on the updated shooting interface; and
the method further comprises:
in response to detecting an operation of ignoring the mismatched key point that is triggered on the updated shooting interface, updating the detection result, wherein the updated detection result indicates that the mismatched key point is in a matching state with the viewfinder image, or the updated detection result indicates that there is no the mismatched key point in the at least one posture shooting key point, and continuing to perform the updating the shooting interface based on the detection result.

6. The method of claim 1, wherein, after the updating the shooting interface based on the detection result, the method further comprises:
in response to detecting that the detection result indicates that there is a key point in the at least one posture shooting key point which is mismatched with the viewfinder image, continuing to perform the detecting, based on the at least one posture shooting key point, the viewfinder image displayed on the shooting interface to obtain the detection result.

7. The method of claim 6, wherein, the method further comprises:
in response to detecting that a duration in which the mismatched key point is in a mismatching state with the viewfinder image reaches a preset duration, updating the detection result, wherein the updated detection result indicates that the mismatched key point is in a matching state with the viewfinder image or the updated detection result indicates that there is no the mismatched key point in the at least one posture shooting key point, and continuing to perform the updating the shooting interface based on the detection result.

8. The method of claim 7, wherein, in response to detecting that a duration in which the mismatched key point is in a mismatching state with the viewfinder image reaches a preset duration, updating the detection result, comprises:
in response to detecting that the duration in which the mismatched key point is in the mismatching state with the viewfinder image reaches the preset duration, displaying preset information on the shooting interface, wherein the preset information inquires whether to ignore the mismatched key point; and
in response to detecting that a trigger operation for the preset information indicates to ignore the mismatched key point, updating the detection result.

9. The method of claim 1, wherein, the updating the shooting interface based on the detection result comprises at least one of:
in response to detecting that the detection result indicates that there is a key point in the at least one posture shooting key point which is matched with the viewfinder image, updating the shooting interface based on the matched key point, wherein the matched key point is weakly displayed or not displayed on the updated shooting interface; or
in response to detecting that the detection result indicates that each key point in the at least one posture shooting key point is matched with the viewfinder image, shooting the viewfinder image, or displaying prompt information on the shooting interface, wherein the prompt information indicates that the viewfinder image meets a shooting requirement.

10. The method of claim 1, wherein, the method is applied to an electronic device, and the method further comprises:
synchronizing the shooting interface to a display device, wherein the display device is independent of the electronic device.

11. The method of claim 1, wherein, the method further comprises:
converting text data generated based on the detection result into speech data for playing, wherein the text data indicates a matching result between some or all of the at least one posture shooting key point and the viewfinder image;
or,
converting some or all of the updated shooting interface into speech data for playing.

12. The method of claim 1, wherein, in response to detecting the operation of acquiring the reference image that is triggered on the shooting interface, acquiring the at least one posture shooting key point from the reference image, comprises:
in response to detecting the operation of acquiring the reference image that is triggered on the shooting interface, displaying the reference image in a display area of the shooting interface;
in response to detecting an operation of analyzing the reference image that is triggered on the shooting interface, analyzing the reference image to obtain the at least one posture shooting key point, and adding and displaying each posture shooting key point on the reference image according to a position of a body part described by each posture shooting key point in the reference image; and
the detecting, based on the at least one posture shooting key point, the viewfinder image displayed on the shooting interface to obtain the detection result comprises:
in response to detecting an operation of displaying the viewfinder image that is triggered on the shooting interface, displaying the viewfinder image in the display area, and detecting, based on the at least one posture shooting key point, the viewfinder image displayed on the shooting interface to obtain the detection result.

13. An electronic device, comprising: a processor and a memory, wherein
the memory is configured to store instructions or a computer program; and
the processor is configured to execute the instructions or the computer program in the memory to cause the electronic device to perform:
displaying a shooting interface;
in response to detecting an operation of acquiring a reference image that is triggered on the shooting interface, acquiring at least one posture shooting key point from the reference image, wherein different posture shooting key points describe different body parts; and
detecting, based on the at least one posture shooting key point, a viewfinder image displayed on the shooting interface to obtain a detection result, wherein the detection result comprises a matching result between each of the at least one posture shooting key point and the viewfinder image, and updating the shooting interface based on the detection result.

14. The electronic device of claim 13, wherein, the updating the shooting interface based on the detection result comprises:
in response to detecting that the detection result indicates that there is a key point in the at least one posture shooting key point which is mismatched with the viewfinder image, updating the shooting interface based on the mismatched key point, wherein the mismatched key point is highlighted on the updated shooting interface.

15. The electronic device of claim 13, wherein, the updating the shooting interface based on the detection result comprises at least one of:
in response to detecting that the detection result indicates that there is a key point in the at least one posture shooting key point which is matched with the viewfinder image, updating the shooting interface based on the matched key point, wherein the matched key point is weakly displayed or not displayed on the updated shooting interface; or
in response to detecting that the detection result indicates that each key point in the at least one posture shooting key point is matched with the viewfinder image, shooting the viewfinder image, or displaying prompt information on the shooting interface, wherein the prompt information indicates that the viewfinder image meets a shooting requirement.

16. The electronic device of claim 13, wherein, in response to detecting the operation of acquiring the reference image that is triggered on the shooting interface, acquiring the at least one posture shooting key point from the reference image, comprises:
in response to detecting the operation of acquiring the reference image that is triggered on the shooting interface, displaying the reference image in a display area of the shooting interface;
in response to detecting an operation of analyzing the reference image that is triggered on the shooting interface, analyzing the reference image to obtain the at least one posture shooting key point, and adding and displaying each posture shooting key point on the reference image according to a position of a body part described by each posture shooting key point in the reference image; and
the detecting, based on the at least one posture shooting key point, the viewfinder image displayed on the shooting interface to obtain the detection result comprises:
in response to detecting an operation of displaying the viewfinder image that is triggered on the shooting interface, displaying the viewfinder image in the display area, and detecting, based on the at least one posture shooting key point, the viewfinder image displayed on the shooting interface to obtain the detection result.

17. A non-transitory computer-readable storage medium, wherein instructions or a computer program are stored in the computer-readable medium, and the instructions or the computer program, when running on a device, cause the device to perform:
displaying a shooting interface;
in response to detecting an operation of acquiring a reference image that is triggered on the shooting interface, acquiring at least one posture shooting key point from the reference image, wherein different posture shooting key points describe different body parts; and
detecting, based on the at least one posture shooting key point, a viewfinder image displayed on the shooting interface to obtain a detection result, wherein the detection result comprises a matching result between each of the at least one posture shooting key point and the viewfinder image, and updating the shooting interface based on the detection result.

18. The non-transitory computer-readable storage medium of claim 17, wherein, the updating the shooting interface based on the detection result comprises:
in response to detecting that the detection result indicates that there is a key point in the at least one posture shooting key point which is mismatched with the viewfinder image, updating the shooting interface based on the mismatched key point, wherein the mismatched key point is highlighted on the updated shooting interface.

19. The non-transitory computer-readable storage medium of claim 17, wherein, the updating the shooting interface based on the detection result comprises at least one of:
in response to detecting that the detection result indicates that there is a key point in the at least one posture shooting key point which is matched with the viewfinder image, updating the shooting interface based on the matched key point, wherein the matched key point is weakly displayed or not displayed on the updated shooting interface; or
in response to detecting that the detection result indicates that each key point in the at least one posture shooting key point is matched with the viewfinder image, shooting the viewfinder image, or displaying prompt information on the shooting interface, wherein the prompt information indicates that the viewfinder image meets a shooting requirement.

20. The non-transitory computer-readable storage medium of claim 17, wherein, in response to detecting the operation of acquiring the reference image that is triggered on the shooting interface, acquiring the at least one posture shooting key point from the reference image, comprises:
in response to detecting the operation of acquiring the reference image that is triggered on the shooting interface, displaying the reference image in a display area of the shooting interface;
in response to detecting an operation of analyzing the reference image that is triggered on the shooting interface, analyzing the reference image to obtain the at least one posture shooting key point, and adding and displaying each posture shooting key point on the reference image according to a position of a body part described by each posture shooting key point in the reference image; and
the detecting, based on the at least one posture shooting key point, the viewfinder image displayed on the shooting interface to obtain the detection result comprises:
in response to detecting an operation of displaying the viewfinder image that is triggered on the shooting interface, displaying the viewfinder image in the display area, and detecting, based on the at least one posture shooting key point, the viewfinder image displayed on the shooting interface to obtain the detection result.
